(19) United States
(12) Patent Application Publication
(10) Pub. No.: US 2011/0124321 A1
(43) Pub. Date: May 26, 2011

(54) APPARATUS AND METHOD FOR CHANGING COMMUNICATION MODE IN MOBILE TERMINAL

(75) Inventors: Jin SAGONG, Suwon-si (KR); Hark-Sang KIM, Seoul (KR); Sang-Ryul PARK, Hwaseong-si (KR); Ju-Gab LEE, Hwaseong-si (KR); Youn-Hyoung KIM, Suwon-si (KR)

(73) Assignee: SAMSUNG ELECTRONICS CO. LTD., Suwon-si (KR)

(21) Appl. No.: 12/942,537

(22) Filed: Nov. 9, 2010

(30) Foreign Application Priority Data
Nov. 23, 2009 (KR) 10-2009-0113045

(51) Int. Cl. H04M 3/42

(52) U.S. Cl. 455/414.1

(57) ABSTRACT

An apparatus and a method for changing a communication mode in a mobile terminal are provided. More particularly, an apparatus and a method for changing to a video communication mode using an external key while performing a voice communication mode, or changing a video communication mode to a voice communication mode using the external key in a mobile terminal are provided. The apparatus includes a communication mode manager. The communication mode manager maps a function for changing a communication mode to a communication connect button of an earphone, and enters a video communication mode using the communication connect button.

### PRIORITY

This application claims the benefit under 35 U.S.C. §119(a) of a Korean patent application filed in the Korean Intellectual Property Office on Nov. 23, 2009 and assigned Serial No. 10-2009-0113045, the entire disclosure of which is hereby incorporated by reference.

### BACKGROUND OF THE INVENTION

1. Field of the Invention

The present invention relates to an apparatus and a method for changing a communication mode in a mobile terminal. More particularly, the present invention relates to an apparatus and a method for changing to a video communication mode using an external key while performing a voice communication mode, or changing a video communication mode to a voice communication mode using the external key in a mobile terminal.

2. Description of the Related Art

Recently, mobile terminals are becoming necessities indispensable to modern people and are widely used regardless of age or sex. Service providers and terminal manufacturers competitively develop products (or services), for differentiation from other companies.

For example, the mobile terminals have developed into multimedia devices that can provide a phonebook, games, a Short Message Service (SMS), an Electronic (E)-mail, an alarm or wake-up call, a Motion Picture Expert Group Audio Layer-3 (MP3) player, a digital camera, and a wireless Internet service, and provides various services. As information communication technology including the Internet develops, the mobile terminals support not only a voice communication mode but also a video communication mode.

For video communication, a mobile terminal that supports the video communication mode captures a user's figure and compresses the captured user's moving image to transmit the moving image to a counterpart mobile terminal. The mobile terminal that receives the compressed user's moving image recovers the user's moving image to the original user's moving image to display the moving on a display unit. By doing so, users of the two mobile terminals can communicate with each other while viewing a counterpart user's figure in person. In addition, the user of the mobile terminal may store contents of the video communication in the mobile terminal or may transmit a moving image or picture data stored in the mobile terminal to the counterpart user in real-time during the video communication.

To make use of the video communication mode, the user of the mobile terminal inputs a video communication button provided in the mobile terminal in person, and then enters the video communication mode. Recently, mobile terminals provide an enhanced multimedia function. A user may reproduce a music file and a movie file using an earphone while on the move. As a use frequency of the earphone increases for these and other reasons, the earphone has a button for communication connection, but the communication connect button cannot perform the video communication mode.

When changing to the video communication mode during voice communication connection using the earphone, the user of the mobile terminal inputs the video communication connect button provided in the mobile terminal. Therefore, an apparatus and a method for enabling entrance of the video communication mode using a button of an earphone in a mobile terminal are desired.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for changing a communication mode using an external key in a mobile terminal.

Another aspect of the present invention is to provide an apparatus and a method for changing a communication mode using an earphone in a mobile terminal.

Another aspect of the present invention is to provide an apparatus and a method for enabling communication mode change in a software manner in a mobile terminal.

In accordance with an aspect of the present invention, an apparatus for changing a communication mode in a mobile terminal is provided. The apparatus includes a communication mode manager for mapping a function for changing a communication mode to a communication connect button of an earphone, and for entering a video communication mode using the communication connect button.

In accordance with another aspect of the present invention, a method for changing a communication mode in a mobile terminal is provided. The method includes mapping a function for changing a communication mode to a communication connect button of an earphone, and entering a video communication mode using the communication connect button.

In accordance with another aspect of the present invention, a mobile terminal is provided. The mobile terminal includes a first communication unit for receiving an input from an earpiece having an external key attached thereto, a second communication unit, a controller for performing voice communication and video communication via the second communication unit, and a communication mode manager for mapping a function for changing a communication mode to the external key of the earphone, and for switching between a video communication mode and a voice communication mode based on the input from the external key of the earphone, wherein the controller performs voice communication while operating in the voice communication mode and performs video communication while operating in the video communication mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile terminal that enables a communication mode change according to an exemplary embodiment of the present invention;

FIG. 2 is a flowchart illustrating a process for allowing a user of a mobile terminal to change a communication mode according to an exemplary embodiment of the present invention; and

FIG. 3 is a flowchart illustrating a process for changing a communication mode in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method for changing a communication mode through simple manipulation without changing hardware in a mobile terminal. In the following description, an external key for communication connection denotes a key for generating a control command that changes a voice communication mode to a video communication mode, or the video communication mode to the voice communication mode. Examples of such an external key include a communication connect button of an earphone and a communication connect button of a Bluetooth headset.

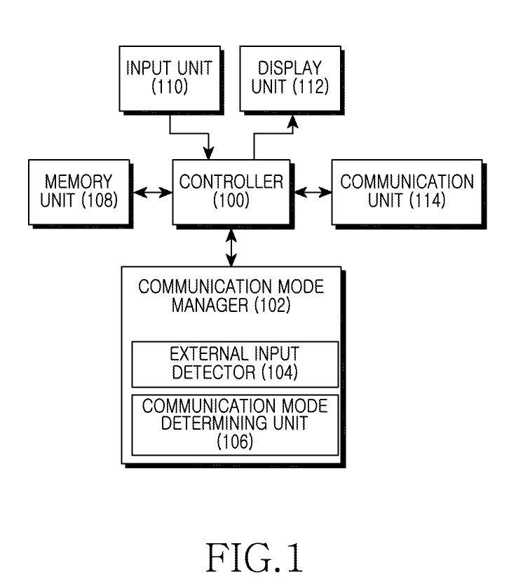

FIG. 1 is a block diagram illustrating a mobile terminal that enables a communication mode change according to an exemplary embodiment of the present invention.

Referring to FIG. 1, the mobile terminal includes a controller 100, a communication mode manager 102, a memory unit 108, an input unit 110, a display unit 112, and a communication unit 114. The communication mode manager 102 may include an external input detector 104 and a communication mode determining unit 106. The mobile terminal may include additional units that are not illustrated here for the sake of clarity. Similarly, the functionality of two or more of the above units may be integrated into a single component.

The controller 100 of the mobile terminal controls overall operations of the mobile terminal. For example, the controller 100 controls general functions as well as voice communication and data communication. In addition to the general and communication functions, according to an exemplary embodiment of the present invention, the controller 100 defines an external key for changing a communication mode using a communication connect button of an earphone and a communication connect button of a Bluetooth headset. When the controller 100 detects the defined key input, the controller 100 performs a video communication mode.

When detecting the external key input while communication is connected, the controller 100 determines a communication mode that is currently performed to change a voice communication mode to a video communication mode, or the video communication mode to the voice communication mode. Additionally, when detecting the external key input during a communication connect request, the controller 100 originates a call in a video mode so that a user may communicate with a counterpart user in the video mode.

When detecting an external key input for changing a communication mode, the communication mode manager 102 performs a communication mode change process of changing the voice communication mode to the video communication mode, or the video communication mode to the voice communication mode under control of the controller 100.

The external input detector 104 of the communication mode manager 102 detects whether an external key defined to change the communication mode is input and provides the input to the communication mode manager 102. When determining that the external key input is detected by the external input detector 104, the communication mode determining unit 106 of the communication mode manager 102 determines a communication mode that is currently performed by the mobile terminal.

The memory unit 108 includes, for example, Read Only Memory (ROM), Random Access Memory (RAM), a flash ROM, and the like. The ROM stores microcodes of programs for processes and controls of the controller 100 and the communication mode manager 102, and various reference data. The RAM serves as a working memory of the controller 100 and stores temporary data that occur during execution of various programs. Additionally, the flash ROM stores various updatable data for storage, such as a phonebook, calling messages, and received messages.

The input unit 110 includes a plurality of function keys, such as numerical key buttons of 0 to 9, a menu button, a cancel button, an OK button, a TALK button, an END button, an Internet access button, navigation key buttons, letter input keys, and the like. The input unit 110 provides key input data (i.e., a communication connect request) corresponding to a key pressed by a user to the controller 100.

The display unit 112 displays status information generated during an operation of the mobile terminal, letters, moving images and still images, and the like. The display unit 112 may be a color Liquid Crystal Display (LCD), an Active Mode Organic Light Emitting Diode (AMOLED), and the like. The display unit 112 may include a touch input device, and when the display unit incorporates a touch input type mobile terminal, the display unit 112 can be used as an input unit.

The communication unit 114 transmits/receives a Radio Frequency (RF) signal of data input/output via an antenna (not illustrated). For example, during transmission, the communication unit 114 channel-codes and spreads data to be transmitted, and then performs an RF process on the signal to transmit the signal. During reception, the communication unit 114 converts a received RF signal into a baseband signal, and despreads and channel-decodes the baseband signal to recover data.

A function of the communication mode manager 102 may be performed by the controller 100 of the mobile terminal. The separate configuration and illustration of the communication mode manager 102 is for exemplary purposes only and for convenience in description, and should not be understood as limiting the scope of the present invention. It would be obvious to those skilled in the art that various modifications may be made within the scope of the present invention. For example, all functions of the communication mode manager 102 may be processed by the controller 100.

An apparatus for changing a communication mode through simple manipulation without a hardware change in a mobile terminal according to an exemplary embodiment of the present invention has been described. Hereinafter, a method for changing a communication mode via an earphone using the above apparatus according to an exemplary embodiment of the present invention is described.

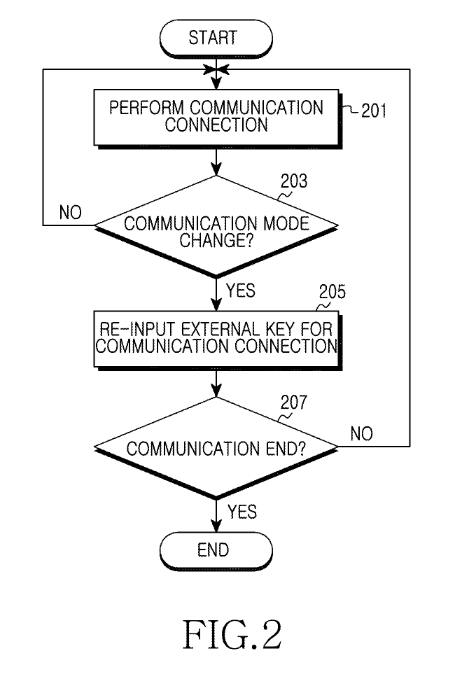

FIG. 2 is a flowchart illustrating a process for allowing a user of a mobile terminal to change a communication mode according to an exemplary embodiment of the present invention.

Referring to FIG. 2, a user of the mobile terminal performs communication connection in step 201. The user of the mobile terminal determines whether an event for changing a communication mode occurs in step 203. The event for changing the communication mode may denote an event for changing to a video communication mode during voice communication mode connection, or changing to the voice communication mode during the video communication mode connection.

If it is determined that the event for changing the communication mode does not occur in step 203, the mobile terminal re-performs the process of step 201 to maintain the communication connection that is currently performed. In contrast, if it is determined that the event for changing the communication mode occurs in step 203, the user of the mobile terminal re-inputs a key for communication connection in step 205.

Step 205 is a process for performing key input for changing the communication mode. For example, the communication mode may be changed by re-inputting a communication button of a Bluetooth headset and a communication button of an earphone while communication is connected. When successively receiving key input for changing the communication mode while the communication is connected, the mobile terminal may change the communication mode. In an exemplary embodiment, when re-receiving the key input once, the mobile terminal may pop up a question for allowing a user to select a communication mode change on a display unit of the mobile terminal, and then change the communication mode according to the user's selection.

The user of the mobile terminal determines whether the communication connection that is currently performed ends in step 207. If it is determined that the communication connection does not end in step 207, the user of the mobile terminal returns back to step 201. In contrast, if it is determined that the communication connection ends in step 207, the process ends.

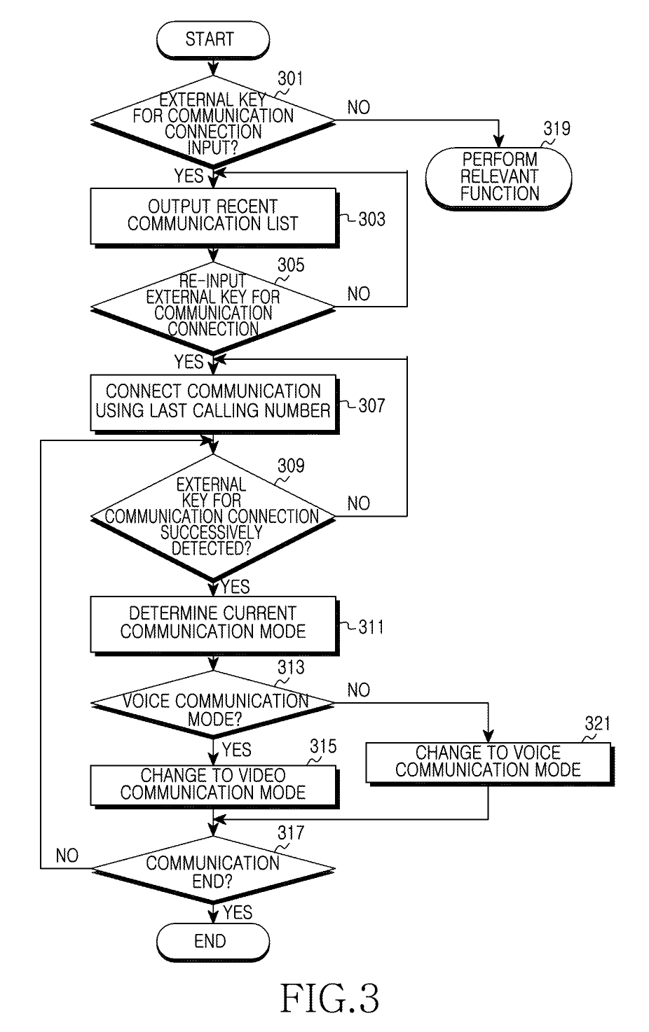

FIG. 3 is a flowchart illustrating a process for changing a communication mode in a mobile terminal according to an exemplary embodiment of the present invention.

Referring to FIG. 3, the mobile terminal determines whether an external key input for communication connection is detected in step 301. The external key for the communication connection may denote a communication connect button of an earphone and a communication connect button of a Bluetooth headset. The communication connect button generates a control command for changing a voice communication mode to a video communication mode, or changing the video communication mode to the voice communication mode.

While not detecting the external key input for the communication connection in step 301, the mobile terminal performs a relevant function (i.e., an idle mode) in step 319. In contrast, when the mobile terminal detects the external key input for the communication connection in step 301, the mobile terminal determines the user performs communication connection and proceeds to step 303 to output a recent communication list.

The mobile terminal determines whether re-input of the external key for communication connection is detected in step 305. The re-input of the external key for communication connection may denote selecting a number to which the user desires to perform communication connection from the recent communication list output in step 303, and then inputting a key for requesting a communication connection to the selected number. The user of the mobile terminal enters a communication connect mode by inputting an external key for communication connection once, and performs communication connection by inputting the external key additional times (re-inputs the external key) while the user has entered the communication connect mode.

While not detecting re-input of the external key for the communication connection in step 305, the mobile terminal re-performs the process of step 303 to determine whether a user's number to be communicated with is received from the recent communication list.

In contrast, when the mobile terminals detects re-input of the external key for the communication connection in step 305, the mobile terminal performs communication connection using a last calling number or performs communication connection using a number selected by the user of the mobile terminal in step 307. The mobile terminal may resolve a problem that video communication cannot be controlled using an external key of an earphone in the conventional mobile terminal by performing communication connection to the calling number in the video communication mode using input of the external key according to an exemplary embodiment of the present invention.

The mobile terminal determines whether a key input for changing communication mode is detected during communication connection in step 309. The key input for changing the communication mode may denote a key input for changing a communication mode of the mobile terminal to a voice communication mode or a video communication mode. The key input may be successively detecting the external key for communication connection during the communication connection.

While not detecting key input for changing the communication mode in step 309, the mobile terminal re-performs the process of step 307 to maintain the communication connection that is currently performed. In contrast, when the mobile terminal detects key input for changing the communication mode in step 309, the mobile terminal determines a current communication mode in step 311.

The mobile terminal determines in step 313 whether the communication mode determined in step 311 is a voice communication mode. If it is determined that the current communication mode is the voice communication mode in step 313, the mobile terminal detects key input for changing the communication mode in step 309, and so changes the voice communication mode to a video communication mode in step 315.

In contrast, if it is determined that the current communication mode is the video communication mode in step 313, the mobile terminal changes the video communication mode to the voice communication mode in step 321. At this point, before changing the communication mode, the mobile terminal may pop up a message informing the user of the communication mode change so that the user may determine the communication mode change, and then change the communication mode according to the user's selection.

The mobile terminal that has changed the communication mode determines whether communication end by the user is detected in step 317. While not detecting the communication end by the user in step 317, the mobile terminal re-performs the process of step 309. In contrast, when the mobile terminal detects the communication end by the user in step 317, the process ends.

A method for changing a communication mode using a communication button of an earphone of a mobile terminal has been described. Exemplary embodiments of the present invention are also applicable to a Bluetooth headset. In addition, exemplary embodiments of the present invention are applicable to headsets communicating with the mobile terminal via other wireless communication protocols, and to headsets connected to the mobile terminal via a cable.

When a user of the mobile terminal sets a mobile terminal that supports a Bluetooth function on a desk and performs a video communication mode, the user of a conventional mobile terminal has to input in person a video communication button of the mobile terminal set on the desk to perform the video communication mode. In contrast, when using a Bluetooth headset (Bluetooth earphone) to which an exemplary embodiment of the present invention has been applied, a user of the mobile terminal allows the mobile terminal and the headset to perform a pairing process through a communication connect button of the headset to connect communication.

The user of the mobile terminal may then perform the video communication mode even without inputting a video communication mode button of the mobile terminal in person by re-inputting the communication connect button of the headset and performing the video communication mode.

The Bluetooth headset has a separate function key to allow a key for the video communication mode to be input or perform the video communication mode using the communication connect button. An exemplary embodiment of the present invention makes communication connection possible in a software manner without changing a separate hardware. When using a headset having the function key, the function key may define a plurality of execution menus to map a plurality of functions besides the video communication function.

As described above, exemplary embodiments of the present invention relate to an apparatus and a method for changing a communication mode using an earphone in a mobile terminal. Exemplary embodiments of the present invention may resolve a problem of having to manipulate the mobile terminal in person when performing video communication using the conventional mobile terminal by making communication mode change possible using a switch of an earphone without changing a separate hardware.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for changing a communication mode in a mobile terminal, the apparatus comprising:
a communication mode manager for mapping a function for changing a communication mode to a communication connect button of an earphone, and for entering a video communication mode using the communication connect button.

2. The apparatus of claim 1, wherein when detecting an input of the communication connect button during communication connection, the communication mode manager changes a communication mode that is currently performed.

3. The apparatus of claim 2, wherein when detecting the input of the communication connect button during the communication connection, the communication mode manager changes to the video communication mode when determining that a voice communication mode is currently performed, and changes to the voice communication mode when determining that the video communication mode is currently performed.

4. The apparatus of claim 3, wherein after determining the communication mode that is currently performed, the communication mode manager outputs a pop-up message for changing the communication mode according to a user's selection.

5. The apparatus of claim 1, wherein the communication connect button of the earphone comprises communication buttons of a Bluetooth headset and a Bluetooth earphone.

6. The apparatus of claim 5, wherein the communication mode manager originates a call in the video communication mode using the communication connect button.

7. A method for changing a communication mode in a mobile terminal, the method comprising:
mapping a function for changing a communication mode to a communication connect button of an earphone; and
entering a video communication mode using the communication connect button.

8. The method of claim 7, wherein the entering of the video communication mode comprises:
when detecting an input of the communication connect button during communication connection, changing a communication mode that is currently performed.

9. The method of claim 8, wherein the entering of the video communication mode comprises:
when detecting the input of the communication connect button during the communication connection, determining the communication mode that is currently performed;
when determining a voice communication mode is currently performed, changing to the video communication mode; and
when determining the video communication mode is currently performed, changing to the voice communication mode.

10. The method of claim 8, wherein the entering of the video communication mode further comprises:
after determining the communication mode that is currently performed, outputting a pop-up message for changing the communication mode according to a user's selection.

11. The method of claim 7, wherein the communication connect button of the earphone comprises communication buttons of a Bluetooth headset and a Bluetooth earphone.

12. The method of claim 11, further comprising:
originating a call in the video communication mode using the communication connect button.

13. The apparatus of claim 1, wherein the communication mode manager sets a command for performing a specific function at the communication connect button of the earphone.

14. The method of claim 7, further comprising setting a command for performing a specific function at the communication connect button of the earphone.

15. A mobile terminal comprising:
a first communication unit for receiving an input from an earpiece having an external key attached thereto;
a second communication unit;
a controller for performing voice communication and video communication via the second communication unit; and
a communication mode manager for mapping a function for changing a communication mode to the external key of the earphone, and for switching between a video communication mode and a voice communication mode based on the input from the external key of the earphone,
wherein the controller performs voice communication while operating in the voice communication mode and performs video communication while operating in the video communication mode.

16. The mobile terminal of claim 15, wherein the first communication unit communicates with the earpiece wirelessly.

17. The mobile terminal of claim 16, wherein the first communication unit communicates with the earpiece via Bluetooth.

18. The mobile terminal of claim 15, wherein the first communication unit includes a port for receiving the earpiece.

19. The mobile terminal of claim 15, wherein the communication mode manager comprises:
an external input detector for detecting the input from the external key of the earphone; and
a communication mode determining unit for determining whether the mobile terminal is operating in the voice communication mode or the video communication mode.

20. The mobile terminal of claim 15, wherein, prior to changing the communication mode, the communication mode manager controls a display unit of the mobile terminal to display a message to a user requesting whether to change the communication mode.
